(19) United States
(12) Patent Application Publication
(10) Pub. No.: US 2006/0089106 A1
(43) Pub. Date: Apr. 27, 2006

(54) Wireless adaptor

(76) Inventor: Chun-Chia Chen, Xihu Town (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/995,287

(22) Filed: Nov. 24, 2004

(30) Foreign Application Priority Data
Oct. 22, 2004 (TW) 093216890

(51) Int. Cl. H04B 1/40

(52) U.S. Cl. 455/74.1; 455/557

(57) ABSTRACT

A wireless adaptor is proposed to make at least a wired device able to be used in a wireless manner. It can be used together with a wireless transmitting/receiving device. The wireless adaptor includes at least a connecting port for connecting with a wired device and receiving signals sent therefrom; an adaptive transmitting/receiving unit for converting the signals sent from the wired device into transmission signals. Therein the transmission signals will be passed to a wireless transmitting/receiving module and converted into radio signals thereby. Furthermore, the wireless transmitting/receiving module can also convert the radio signals emitted from the wireless transmitting/receiving device to transmission signals and pass them to the adaptive transmitting/receiving unit. Subsequently, the adaptive transmitting/receiving unit converts the transmission signals to command signals for the wired device to perform.

### BACKGROUND OF THE INVENTION

1. Field of the Invention

The present invention is related to a wireless adaptor, and more particularly, to an adaptive device that can make at least a wired device able to be used in a wireless manner for convenience.

2. Description of Related Art

With progress of technologies, electronic products are increasing nowadays. Their functionalities become better and better. However, computer peripherals such as earphones, card readers, mice, keyboards, touch pads or microphones still need to be connected to input/output (I/O) ports of computers in a wired manner for use. Hence, plenty of signal transmission wires are needed. These signal transmission wires are not only multifarious but also limited in length. The limits in transmission distance and usage condition make users feel inconvenient extremely.

Due to the problems mentioned above, many wireless products have been developed nowadays, such as wireless mice and wireless keyboards. However, there are still many peripherals not being developed in a wireless manner, such as high-quality earphones and touch pads. They still have some limitations in usage when used in different environments. Sometimes a user already has a wired device but is forced to buy a wireless device with the same functions due to requirements of different environments in usage. That causes an unnecessary waste for buying two similar devices. Furthermore, conventional wireless devices with different transmission signals need to be used together with different wireless transmitting/receiving module. In other words, as the number of used wireless devices increases, the cost for usage or manufacture also increases. That is very uneconomic.

Accordingly, as discussed above, the prior art still has some drawbacks that could be improved. The present invention aims to resolve the drawbacks in the prior art and therefore provides a wireless adaptor to make a wired device able to be used in a wireless manner. In addition, according to requirements in usage, the wireless adaptor of the present invention can be expanded to support multiple wired devices. In this way, the present invention makes conventional wired devices more convenient and resolves the problems mentioned above.

### SUMMARY OF THE INVENTION

An objective of the present invention is to provide a wireless adaptor, which is an interface for transforming a general wired device into a wireless device. Thus, the wired device with the wireless adaptor of the present invention can be used remotely and more convenient in usage.

Another objective of the present invention is to provide wireless adaptor, which can be extended to simultaneously convert multiple different signals sent from multiple wired devices and thus transforms the wired devices into wireless devices at the same time. Furthermore, there is no need to install additional wireless modules corresponding to the wired devices at the remote end. Hence, the cost for extension is reduced.

For achieving the objectives above, the present invention provides a wireless adaptor, which is used together with a wireless receiving device and a remote host to make at least a wired device able to be used in a wireless manner. The wireless adaptor includes at least a connecting port for connecting with the wired device and receiving input signals sent from the wired device; an adaptive transmitting unit for receiving the input signals and converting the input signals into transmission signals; and a wireless transmitting module for receiving the transmission signals and produce corresponding radio signals for wireless transmission. Therein, the wireless transmitting module is further connected with an antenna for passing the radio signals to the wireless receiving device. The wireless adaptor further has a processing unit for modulating the signals sent from multiple wired devices.

For achieving the objectives above, the present invention provides another wireless adaptor, which is used together with a wireless transmitting device and a remote host to make at least a wired device able to be used in a wireless manner. The wireless adaptor includes at least a connecting port for connecting with the wired device and providing signals thereto; a wireless receiving module for receiving radio signals sent from the remote host via the wireless transmitting device to produced wire-dedicated signals; and an adaptive receiving unit for receiving the wire-dedicated signals and converting the wire-dedicated signals into command signals that are capable of being performed by the wired device, wherein the command signals are passed to the wired device for execution via the connecting port. The foresaid wireless receiving module is further connected to an antenna for receiving the radio signals. The wireless adaptor further has a processing unit for modulating multiple signals.

Numerous additional features, benefits and details of the present invention are described in the detailed description, which follows.

### BRIEF DESCRIPTION OF THE DRAWINGS

The foregoing aspects and many of the attendant advantages of this invention will be more readily appreciated as the same becomes better understood by reference to the following detailed description, when taken in conjunction with the accompanying drawings, wherein:

FIG. 1 is a block diagram of the first preferred embodiment for a wireless adaptor in accordance with the present invention;

FIG. 2 is a block diagram of the second preferred embodiment for the wireless adaptor in accordance with the present invention;

FIG. 3 is a block diagram of the third preferred embodiment for the wireless adaptor in accordance with the present invention;

FIG. 4 is a block diagram of the fourth preferred embodiment for the wireless adaptor in accordance with the present invention; and

FIG. 5 is a block diagram of the fifth preferred embodiment for the wireless adaptor in accordance with the present invention.

### DETAILED DESCRIPTION OF PREFERRED EMBODIMENTS

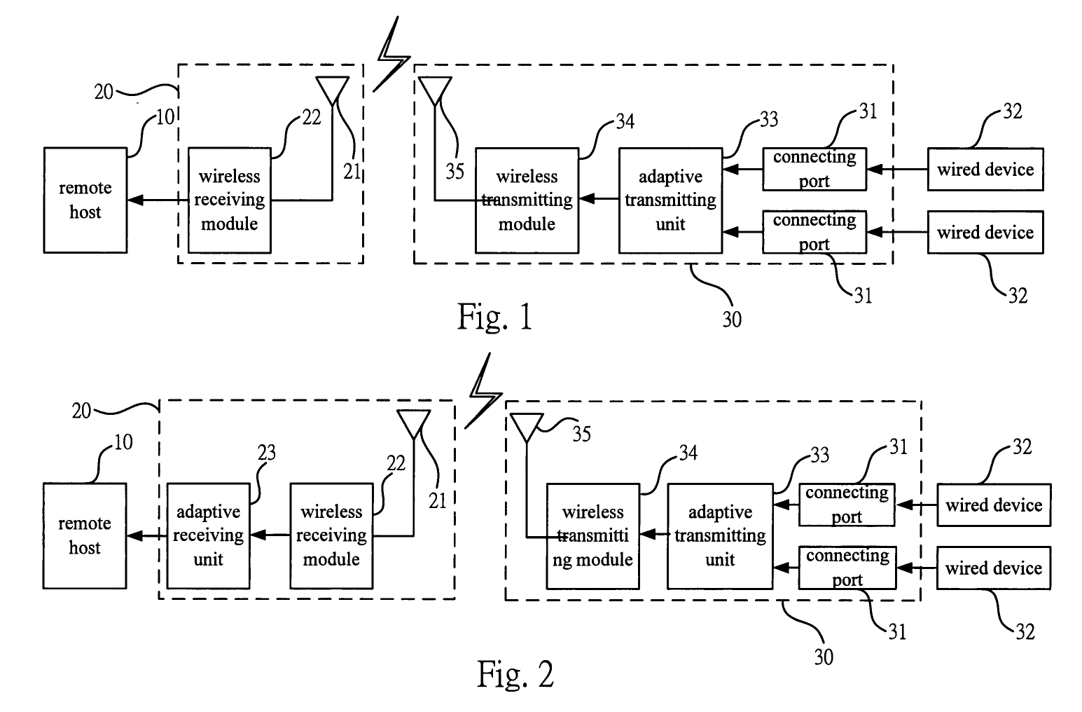

Reference is made to FIG. 1, which is a block diagram of the first preferred embodiment for a wireless adaptor in accordance with the present invention. This embodiment makes a wired device able to be used in a wireless manner. It needs to be used together with a remote host 10 equipped with a wireless receiving device 20. For example, the wired device can be a wired keyboard, a wired mouse, a wired track ball, a wired touch pad, a wired microphone, a wired card reader and so forth. The remote host 10 can be a computer, a stereo or a personal digital assistant (PDA).

As shown in FIG. 1, the wireless adaptor 30 of the present invention includes at least a connecting port 31 for connecting with a wired device 32 and receiving signals sent therefrom; an adaptive transmitting unit 33 for converting the signals sent from the wired device 32 into transmission signals according to the type of the wired device 32, wherein the transmission signals are adaptive to be received and used by a wireless transmitting module 34; and an antenna 35 for receiving the signals sent from the wireless transmitting module 34 and transmitting the radio signals.

Therein, since the wireless transmitting module 34 is a radio module, the signals sent from the wired device 32 need to be processed and converted into transmission signals by the adaptive transmitting unit 33 for the wireless transmitting module 34 to receive and use. After that, the wireless transmitting module 34 generates radio signals according to the transmission signals and delivers them by the antenna 35. Furthermore, the wireless transmitting module 34 can be a Blue Tooth module.

In the preferred embodiment, a wired keyboard is transformed into a wireless keyboard by using the wireless adaptor. In order to details the operation of the embodiment, the remote host 10 equipped with the wireless receiving device 20 is also provided. When a user connects a wired keyboard with the connecting port 31 of the present invention and presses the wired keyboard, the wired keyboard send out signals to the adaptive transmitting unit 33 via the connecting port 31 for converting the signals into transmission signals. After that, the transmission signals are delivered to the wireless transmitting module 34 for converting the transmission signals into radio signals. Then, the radio signals are transmitted to the wireless receiving device 20 via the antenna 35.

Therein, the antenna 21 receives the radio signals and then delivers the radio signals to a wireless receiving module 22. Then, the wireless receiving module 22 converts the radio signals into dedicated signals adaptive to be received and used by the remote host 10. After that, the dedicated signals are passed to a central processing unit (CPU) of the remote host 10 for converting the dedicated signals into command signals. Finally, the remote host 10 performs a corresponding operation according to the command signals. In this embodiment, since the wired device 32 is a wired keyboard, the corresponding operation of the remote host 10 is to output corresponding words that are keyed in via the wired keyboard.

By using the wireless adaptor 30 of the present invention, a user can make the wired device 32 transformed into a wireless device. Hence, he can reduce the waste for buying another wireless device and its accessories.

Reference is made to FIG. 2, which is a block diagram of the second preferred embodiment for the wireless adaptor in accordance with the present invention. This embodiment is different to the first embodiment because the wireless receiving device 20 further has an adaptive receiving unit 23 in this embodiment. When the wireless receiving device 20 passes the received radio signals to the adaptive receiving unit 23, the radio signals are converted into dedicated signals in advance via the adaptive receiving unit 23 and then passed to the remote host 10, wherein the remote host 10 can directly use the dedicated signals. The dedicated signals don't need to be processed by the CPU of the remote host 10 for signal conversion. Hence, that can reduce the burden of the CUP.

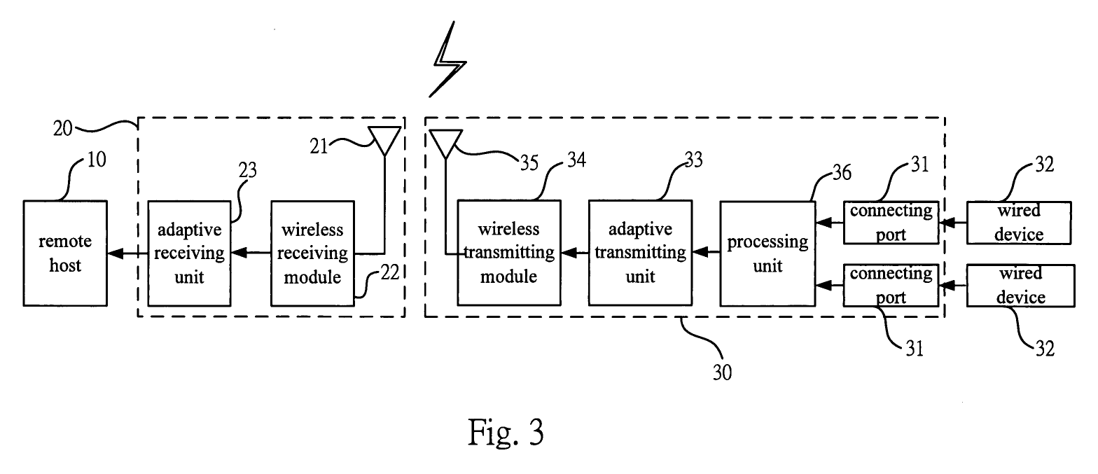

Reference is made to FIG. 3, which is a block diagram of the third preferred embodiment for the wireless adaptor in accordance with the present invention. This embodiment is different to the first and second embodiments because the wireless adaptor 30 further has a processing unit 36 in this embodiment. When the connecting ports 31 receive different signals from the wired devices 32, the adaptive transmitting unit 33 cannot directly process these different signals and transmit them. Hence, the present invention provides the processing unit 36 to combine these different signals and make them capable of being processed by the adaptive transmitting unit 33. Then, after processed by the adaptive transmitting unit 33, the signals are sent to the wireless receiving device 20 through the wireless transmitting module 34 and antenna 35. Subsequently, the CPU of the remote host 10 receives and processes the combinative signals. After that, the CPU produces multiple command signals for performing the corresponding operations.

As described above, the wireless adaptor 30 of the present invention can be extended to convert multiple different signals sent from different wired devices 32 and hence the present invention can be used to transform multiple wired devices into wireless devices. Thereby, by using the present invention, it is not necessary to use additional wireless receiving devices 20 for multiple different wired devices 32. Thus, in comparison with conventional wireless apparatuses, the present invention can be used more extensively. The present invention can be applied not only to transform one wired device 32 into a wireless device but also to make multiple wired devices 32 having different output signals be used in a wireless manner.

Reference is made to FIG. 4, which is a block diagram of the fourth preferred embodiment for the wireless adaptor in accordance with the present invention. In this embodiment, the wired devices 52 are wired earphones, which are transformed into wireless earphones by using the present invention and thereby receive the sound signals sent from the remote host 10. When an audio unit of the remote host 10 has sound signals ready for transmission to the wired devices 52, i.e. the wired earphones, the audio unit first sends the sound signals to the CPU of the remote host 10 for conversion. Then, the CPU converts the sound signals and sends the converted signals to the wireless transmitting module 41, which can be a Bluetooth module. Therein, since the wireless transmitting module 41 is a radio module, the sound signals should be converted to transmission signals adaptive for the wireless transmitting module 41 to use. After the signal conversion, the wireless transmitting module 41 can use the converted sound signals to produce radio signals and send the radio signals to the wireless adaptor 50 via the antenna 42. Then, the sound signals are passed to the corresponding wired device for playing.

Therein, the antenna 53 is used to receive the radio signals and pass them to the wireless receiving module 54. After the radio signals are received, the wireless receiving module 54 converts the radio signals to transmission signals and then the adaptive receiving unit 55 converts the transmission signals to command signals. According to the category of the wired device 52, the signals conversion performed by the adaptive receiving unit 55 makes the transmission signals converted to the command signals suitable for usage of the wired device 52. It means that the transmission signals are converted to the sound signals capable of being received and played by the wired earphones. After that, the sound signals are passed to the wired devices 52 (the wired earphones) via the connecting ports 51.

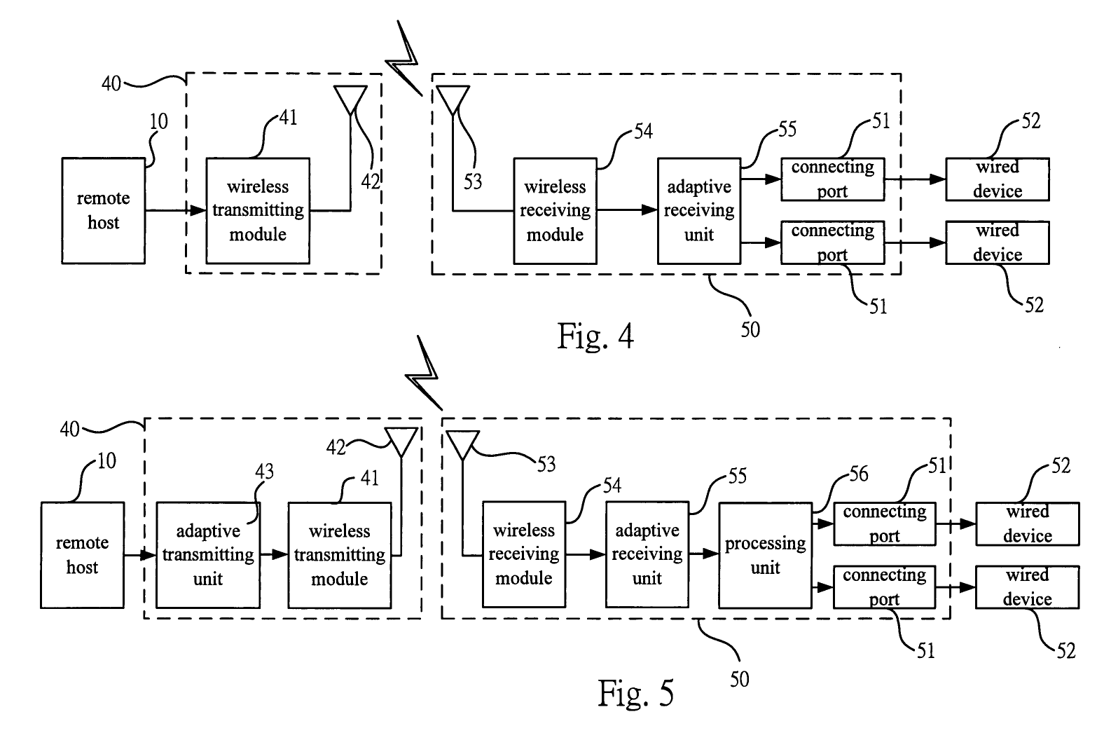

Reference is made to FIG. 5, which is a block diagram of the fifth preferred embodiment for the wireless adaptor in accordance with the present invention. This embodiment is slightly different to the fourth embodiment. The difference is that the wireless transmitting device 40 can further have an adaptive transmitting unit 43 as the second embodiment shown in FIG. 2. In this way, the ready signals of the remote host 10 can be directly delivered to the adaptive transmitting unit 43 for signal conversion. The adaptive transmitting unit 43 is capable of converting the signals sent from the remote host 10 into transmission signals that are adaptive for the wireless transmitting module 41 to receive and use. Hence, the CPU doesn't need to perform the same operation so that its burden can be reduced thereby. In addition, the wireless adaptor 50 can further have a processing unit 56 as the third embodiment shown in FIG. 3. When the remote host 10 wants to transmit multiple signals to different wired devices 52, the CPU of the remote host 10 combines the signals. After that, the combined signals are further processed to produce radios signals and then the radio signals are sent out via the antenna 42. After the antenna 53 of the wireless adaptor 50 receives the radio signals, the radio signals are processed to produce command signals via the wireless receiving module 54 and the adaptive receiving unit 55. Then, the processing unit 56 decomposes the command signals and passes the decomposed signals to the corresponding wired devices 52 for execution.

In the present invention, the receiving structure and the transmitting structure of the wireless adaptor can be integrated as one. Thereby, the wireless adaptor becomes a transmitting/receiving device for transmitting and receiving radio signals. The adaptive transmitting/receiving unit can be used to convert the signals sent from the wired devices and pass the converted signals to the wireless transmitting/receiving module. After that, the wireless transmitting/receiving module converts the signals received to produce radio signals. On the other hand, the adaptive transmitting/receiving unit can also be used to convert the signals received from the wireless transmitting/receiving module into command signals and pass them to the wired devices. Furthermore, the wireless receiving device 20 and the wireless transmitting device 40 of the remote host 10 can also be integrated as one.

Summing up, the wireless adaptor of the present invention can transform the wired devices into wireless devices for being used remotely. Thus, the present invention removes the limitation of the signal transmission lines and hence is more convenient in usage. Furthermore, the present invention is easily extended for more wired devices without installing additional wireless transmitting/receiving devices at the remote end. Thus, the cost for extension is reduced.

Although the present invention has been described with reference to the preferred embodiment thereof, it will be understood that the invention is not limited to the details thereof. Various substitutions and modifications have been suggested in the foregoing description, and other will occur to those of ordinary skill in the art. Therefore, all such substitutions and modifications are embraced within the scope of the invention as defined in the appended claims.

What is claimed is:

1. A wireless adaptor, which is used together with a wireless receiving device to make at least a wired device able to be used in a wireless manner, the wireless adaptor comprising:
at least a connecting port for connecting with the wired device and receiving input signals sent from the wired device;
an adaptive transmitting unit for receiving the input signals and converting the input signals into transmission signals;
a wireless transmitting module for receiving the transmission signals and producing corresponding radio signals; and
a first antenna for receiving the radio signals and passing them to the wireless receiving device.

2. The wireless adaptor as claimed in claim 1, wherein the adaptive transmitting unit converts the input signals into the transmission signals suitable for the wireless transmitting module to receive and process in accordance with a category of the wired device.

3. The wireless adaptor as claimed in claim 1, wherein the wireless receiving device is connected to a remote host and passes the radio signals received to the remote host for execution.

4. The wireless adaptor as claimed in claim 3, wherein the wireless receiving device has a second antenna and a wireless receiving module, the second antenna is used to receive the radio signals and pass them to the wireless receiving module to produce wire-dedicated signals that are adaptive for a central processing unit (CPU) of the remote host, and the CPU converts the wire-dedicated signals into command signals.

5. The wireless adaptor as claimed in claim 3, wherein the wireless receiving device has a second antenna, a wireless receiving module and an adaptive receiving unit, the second antenna is used to receive the radio signals and pass them to the wireless receiving module to produce wire-dedicated signals, which are then passed to the adaptive receiving unit and converted into command signals thereby, and the command signals are passed to the remote host.

6. The wireless adaptor as claimed in claim 4, wherein the wireless receiving module is a Bluetooth module.

7. The wireless adaptor as claimed in claim 5, wherein the wireless receiving module is a Bluetooth module.

8. The wireless adaptor as claimed in claim 1, wherein the adaptive transmitting unit further has a processing unit used to receive and combine signals sent from a plurality of wired devices to produce combinative signals.

9. The wireless adaptor as claimed in claim 1, wherein the wireless transmitting module is a Bluetooth module.

10. The wireless adaptor as claimed in claim 1, wherein the wired device is a wired keyboard, a wired mouse, a wired track ball, a wired touch pad, a wired microphone or a card-reading machine.

11. A wireless adaptor, which is used together with a wireless transmitting device to make at least a wired device able to be used in a wireless manner, the wireless adaptor comprising:
at least a connecting port for connecting with the wired device;
a first antenna for receiving radio signals sent from the wireless transmitting device;
a wireless receiving module for receiving the radio signals to produced wire-dedicated signals; and
an adaptive receiving unit for receiving the wire-dedicated signals and converting the wire-dedicated signals into command signals that are capable of being performed by the wired device, wherein the command signals are passed to the wired device for execution via the connecting port.

12. The wireless adaptor as claimed in claim 11, wherein the adaptive receiving unit converts the wire-dedicated signals into the command signals in accordance with a category of the wired device.

13. The wireless adaptor as claimed in claim 11, wherein the wireless transmitting device is connected to a remote host and used for the remote host to send input signals to the wireless adaptor.

14. The wireless adaptor as claimed in claim 13, wherein the remote host has a CPU, which converts the input signals into transmission signals adaptive for the wireless transmitting device in accordance with a category of the wired device.

15. The wireless adaptor as claimed in claim 14, wherein the wireless transmitting device has a second antenna and a wireless transmitting module, the wireless transmitting module is used to receive the transmission signals sent from the CPU and produce the radio signals thereby, and the radio signals are passed to the antenna for wireless transmission.

16. The wireless adaptor as claimed in claim 13, wherein the wireless transmitting device has a adaptive transmitting unit, a wireless transmitting module and a second antenna, the adaptive transmitting unit receives the input signals sent from the remote host and converts them into transmission signals adaptive for the wireless transmitting module in accordance with a category of the wired device, the wireless transmitting module is used to receive the transmission signals and produce the radio signals thereby, and the radio signals are passed to the antenna for wireless transmission.

17. The wireless adaptor as claimed in claim 15, wherein the wireless transmitting module is a Bluetooth module.

18. The wireless adaptor as claimed in claim 16, wherein the wireless transmitting module is a Bluetooth module.

19. The wireless adaptor as claimed in claim 11, wherein the adaptive receiving unit further connects with a processing unit, the adaptive receiving unit passes the command signals to the processing unit, and the processing unit decomposes the command signals and passes the decomposed signals to corresponding wired devices.

20. The wireless adaptor as claimed in claim 11, wherein the wireless receiving module is a Bluetooth module.

21. The wireless adaptor as claimed in claim 11, wherein the wired device is a wired earphone, the radio signals sent from the wireless transmitting device convey audio information, and the wired earphone receives the audio information via the wireless adaptor and plays the audio information.
